(19) United States
(12) Patent Application Publication
(10) Pub. No.: US 2017/0213629 A1
(43) Pub. Date: Jul. 27, 2017

(54) COIL ASSEMBLY AND METHOD FOR MANUFACTURING COIL ASSEMBLY

(71) Applicant: GOTO DENSHI CO., LTD., Sagae-shi (JP)

(72) Inventors: Yoshihide GOTO, Sagae-shi (JP); Taiki GOTO, Sagae-shi (JP)

(73) Assignee: GOTO DENSHI CO., LTD., Sagae-shi (JP)

(21) Appl. No.: 15/008,200

(22) Filed: Jan. 27, 2016

(51) Int. Cl. H01F 5/02; H01F 41/10; H01F 41/076

(52) U.S. Cl. CPC H01F 5/02; H01F 41/076; H01F 41/10

(57) ABSTRACT

A coil assembly includes a bobbin and a coil wound around the bobbin. The bobbin includes a terminal configured to hold a winding start part or a winding finish part of the coil. The terminal includes a first holding part configured to hold a first part of the winding start part or the winding finish part, and a second holding part configured to hold a second part of the winding start part or the winding finish part, the second part being apart from the first part.

### TECHNICAL FIELD

The present invention relates to a coil assembly and a manufacturing method thereof.

### BACKGROUND OF THE DISCLOSURE

In recent years, a coil assembly is used for driving a lens of a camera of an electric device, such as a smart phone, tablet, or other such device. The coil assembly includes a bobbin, and a coil wound around the bobbin.

The coil assembly holds a winding start part and a winding finish part of the coil by winding them around terminals, which are formed on the bobbin.

However, as the electric devices are becoming smaller, a size of the bobbin and a diameter of the coil are becoming smaller, too. Therefore, it becomes more difficult, for manufacturing workers, to wind the winding start part and the winding finish part of the coil around the terminals. In addition, it becomes even more difficult to automate the entire manufacturing process.

### SUMMARY OF THE INVENTION

The present invention has the objective of providing a coil assembly that can be easily manufactured and its manufacturing method that can be easily implemented and automated.

In one embodiment, the present disclosure provides a coil assembly structure. The coil assembly includes a bobbin; and a coil wound around the bobbin. The bobbin includes a terminal configured to hold a winding start part or a winding finish part of the coil. And, the terminal includes a first holding part configured to hold a first part of the winding start part or the winding finish part, and a second holding part configured to hold a second part of the winding start part or the winding finish part, the second holding part being apart from the first holding part.

In another embodiment, the present disclosure provides a process for manufacturing a coil assembly. The process comprises the steps of holding a first part of a winding start part or a winding finish part of a coil to a first holding part of a terminal of a bobbin, and holding a second part of the winding start part or the winding finish part to a second holding part of the terminal. The second holding part being apart from the first holding part.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF DRAWINGS

The present disclosure is described in conjunction with the appended figures:

FIG. 1 depicts a top view of an embodiment of a coil assembly structure.

FIG. 2 is a front view of the embodiment depicted in FIG. 1.

FIG. 3 is a right side view of the embodiment depicted in FIG. 1.

FIG. 4 illustrates a partial view showing a first embodiment of a terminal of the coil assembly.

FIG. 5 is a perspective view of the first embodiment of the terminal depicted in FIG. 4.

FIG. 6 is a top view of the first embodiment of the terminal depicted in FIG. 5.

FIG. 7 illustrates a perspective view showing a second embodiment of a terminal of the coil assembly.

FIG. 8 illustrates a perspective view showing a third embodiment of the terminal of the coil assembly.

FIG. 9 is a perspective view of the third embodiment of the terminal depicted in FIG. 8 with more detail.

FIG. 10 is a top view of the third embodiment of the terminal depicted in FIG. 9.

FIG. 11 illustrates a perspective view showing a fourth embodiment of the terminal of the coil assembly.

FIG. 12 illustrates a perspective view showing an alternative view of the fourth embodiment of the terminal.

FIG. 13 illustrates a perspective view showing a fifth embodiment of the terminal of the coil assembly.

FIG. 14 illustrates a perspective view showing an alternative view of the fifth embodiment of the terminal.

FIG. 15 illustrates a perspective view showing a sixth embodiment of the terminal of the coil assembly.

FIG. 16 illustrates a top view showing a seventh embodiment of the terminal of the coil assembly.

FIG. 17 illustrates a top view showing an alternative embodiment of the terminal depicted in FIG. 16.

In the appended figures, similar components and/or features may have the same reference label. Further, various components of the same type may be distinguished by following the reference label by a dash and a second label that distinguishes among the similar components. If only the first reference label is used in the specification, the description is applicable to any one the similar components having the same first reference label irrespective of the second reference label.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

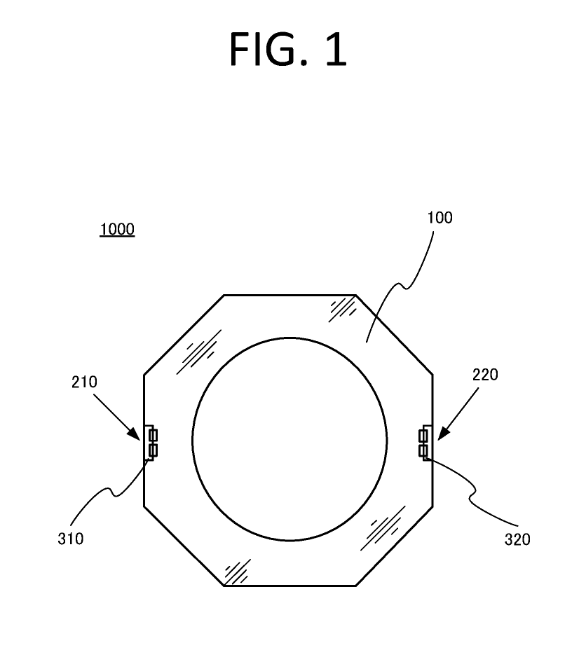

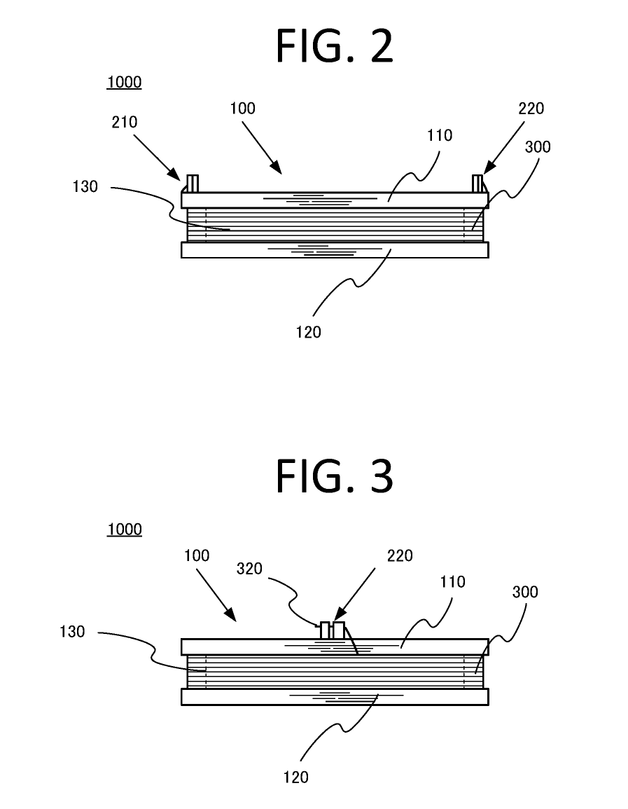

Referring first to FIGS. 1-3, a top view, a front view, and a right side view of a coil assembly according to the embodiments of the present invention are shown. As shown in these figures, a coil assembly 1000 includes a bobbin 100 and a coil 300. The bobbin 100 may include a cylindrical member 130, a first flange 110, and a second flange 120. The first flange 110 is provided at a first edge of the cylindrical member 130. The second flange 120 is provided at a second edge of the cylindrical member 130. The coil 300 is wound around the bobbin 100. The bobbin 100 further includes a first terminal 210 and a second terminal 220. The first terminal 210 and the second terminal 220 are provided on the first flange 110 and are located opposite to and away from each other. The first terminal 210 is configured to hold a winding start part 310 of the coil 300. The second terminal 220 is configured to hold a winding finish part 320 of the coil 300.

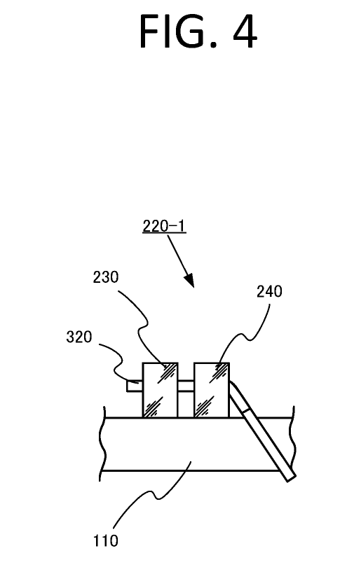

Referring next to FIG. 4, a partial view illustrating a first exemplary embodiment of a terminal of the coil assembly, the second terminal 220, is shown. As shown in this figure, the second terminal 220 may include a first holding part 230 and a second holding part 240. The second holding part 240 is apart from the first holding part 230. It is understood that the preliminary soldering treatment is carried out on the winding finish part 320. It should in particular be noted that the first terminal 210 also has the same structure as the second terminal 220.

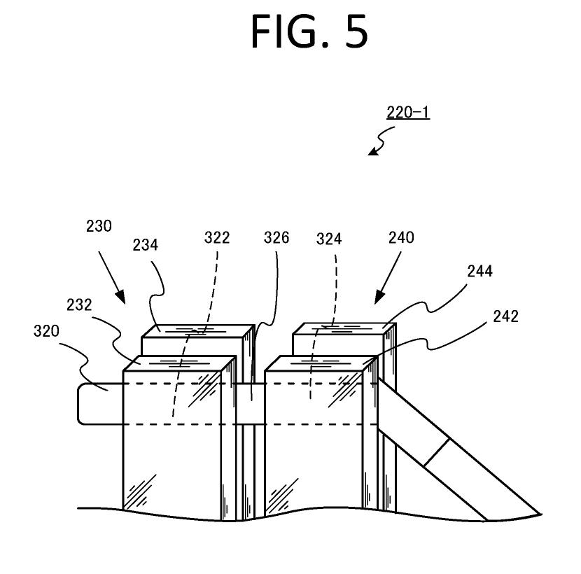

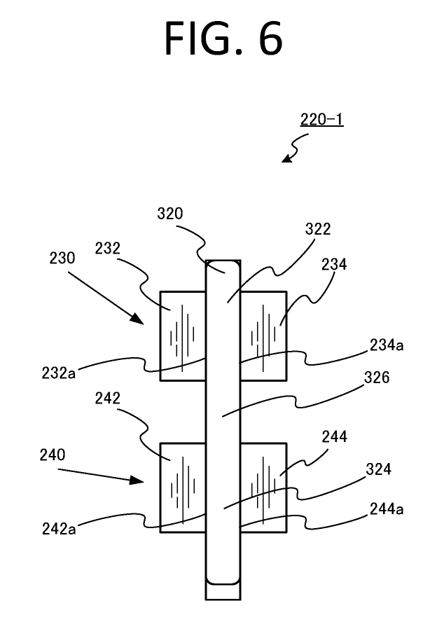

FIGS. 5-6 illustrate, respectively, a perspective view and a top view of the first embodiment of the second terminal 220. As shown in these figures, the first holding part 230 is configured to hold a first part 322 of the winding finish part 320. The second holding part 240 is configured to hold a second part 324 of the winding finish part 320. The second part 324 is apart from the first part 322.

The first holding part 230 may include a pair of first projecting strip members 232, 234. The pair of first projecting strip members 232, 234 are projected from the bobbin 100. The first projecting strip member 232 has a first clipping surface 232a. Similarly, the first projecting strip member 234 has a first clipping surface 234a. The first clipping surfaces 232a. 234a are configured to clip the first part 322 of the winding finish part 320. The first holding part 240 may include a pair of second projecting strip members 242, 244. The pair of second projecting strip members 242, 244 are projected from the bobbin 100. The second projecting strip member 242 has a second clipping surface 242a. Similarly, the second projecting strip member 244 has a second clipping surface 244a. The second clipping surfaces 242a, 244a are configured to clip the second part 324 of the winding finish part 320.

In this first exemplary embodiment, manufacturing workers only have to insert the first part 322 of the winding finish part 320 between the first projecting strip members 232, 234, and to insert the second part 324 of the winding finish part 320 between the second projecting strip members 242, 244. Thus, according to the first embodiment of the present invention, it is possible to provide a coil assembly that is easy to manufacture and handle. In addition, according to the first embodiment of the present invention, the coil assembly 1000 can be manufactured by the same electronic device manufacturer that embodies the coil assembly 1000. And thus, it becomes possible to provide a coil assembly manufacturing process that can be easily automated.

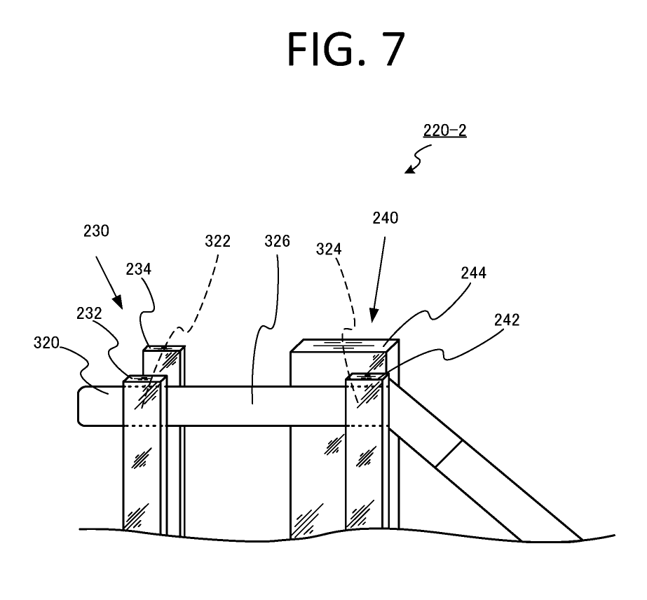

In the first exemplary embodiment of the coil assembly 1000, the width of the first projecting strip members 232, 234 and the second projecting strip members 242, 244 are the same. However, the width of the first projecting strip members 232, 234 and the second projecting strip members 242, 244 can be varied. With reference to FIG. 7, a perspective view illustrating a second embodiment of the terminal 220 is shown. As shown in this figure, the width of the second projecting strip member 244 is larger than the width of the second projecting strip member 242. In this way, the width of the first projecting strip members 232, 234 and the second projecting strip members 242, 244 can be differentiated.

In the second embodiment, as with the first embodiment, manufacturing workers only have to insert the first part 322 of the winding finish part 320 between the first projecting strip members 232, 234, and to insert the second part 324 of the winding finish part 320 between the second projecting strip members 242, 244. Thus, according to the second embodiment of the present invention, it is possible to provide a coil assembly that is easy to manufacture and handle. In addition, according to the second embodiment of the present invention, the coil assembly 1000 can be manufactured by the same electronic device manufacturer that embodies the coil assembly 1000. And thus, it becomes possible to provide a coil assembly manufacturing process that can be easily automated.

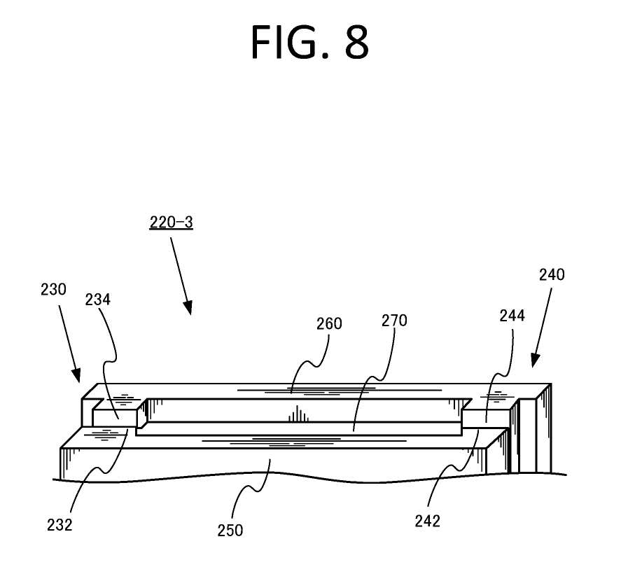

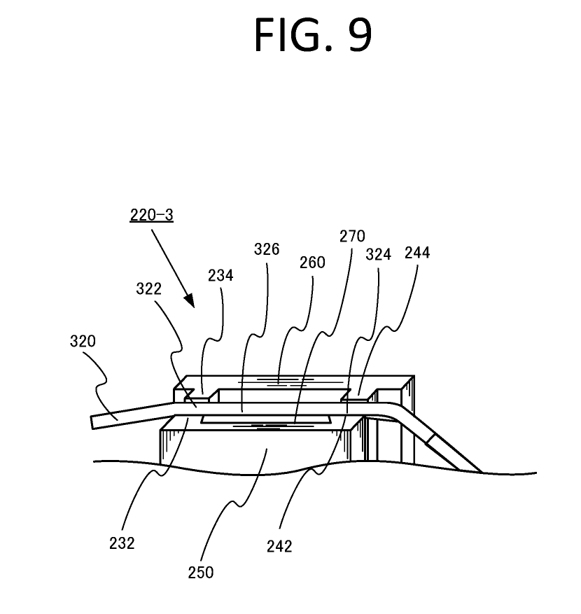

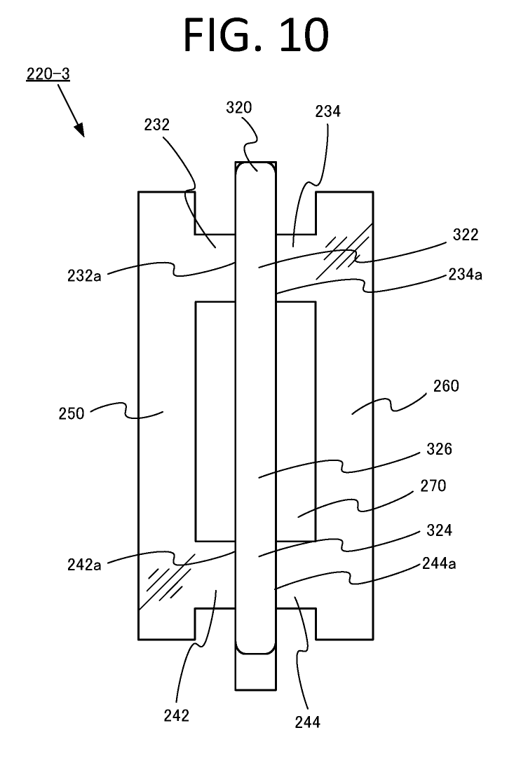

Referring next to FIG. 8, a perspective view of a third embodiment of the second terminal 220 is shown. FIG. 9 illustrates in more detail a perspective view of the third embodiment of the second terminal 220. FIG. 10 represents a top view of the third embodiment of the second terminal 220. As shown in FIGS. 8-10, the second terminal 220, according to the third embodiment of the present invention, may further include a first wall 250 and a second wall 260. The first wall 250 and the second wall 260 are provided on the bobbin 100. The first wall 250 and the second wall 260 are located opposite to each other. One of the pair of first projecting strip members (the first projecting strip member 232) is formed inside of the first wall 250, while the other one of the pair of first projecting strip members (the first projecting strip member 234) is formed inside of the second wall 260. On the other hand, one of the pair of second projecting strip members (the second projecting strip member 242) is formed inside of the first wall 250, while the other one of the pair of second projecting strip members (the second projecting strip member 244) is formed inside of the second wall 260. Further, the second terminal 220 may include a support part 270. The support part 270 is provided in a space surrounded by the first wall 250, the second wall 260, the first projecting strip members 232, 234, and the second projecting strip members 242, 244. The support part 270 is provided at a position, which is lowered from an upper face of the first wall 250, the second wall 260, the first projecting strip members 232, 234, and the second projecting strip members 242, 244 by about a diameter of the winding finish part 320. The support part 270 is configured to support an intermediate part 326 of the winding finish part 320. The intermediate part 326 is formed between the first part 322 and the second part 324 of the winding finish part 320.

In the third embodiment, similar to the first and second embodiments, manufacturing workers only have to insert the first part 322 of the winding finish part 320 between the first projecting strip members 232, 234, and to insert the second part 324 of the winding finish part 320 between the second projecting strip members 242, 244. Thus, according to the third embodiment of the present invention, it is possible to provide a coil assembly that is easy to manufacture and handle. In addition, according to the third embodiment of the present invention, the coil assembly 1000 can be manufactured by the same electronic device manufacturere that embodies the coil assembly 1000. And thus, it becomes possible to provide a coil assembly manufacturing process that can be easily automated. In addition, according to the third embodiment of the present invention, the intermediate part 326 of the winding finish part 320 is supported by the support part 270. Thus, it becomes possible to prevent the false insertion of the intermediate part 326 into the lower portions of the first holding part 230 and the second holding part 240. As a result, it becomes easier to connect an attachment (for example, a plate spring, as it will be described further below) to the intermediate part 326.

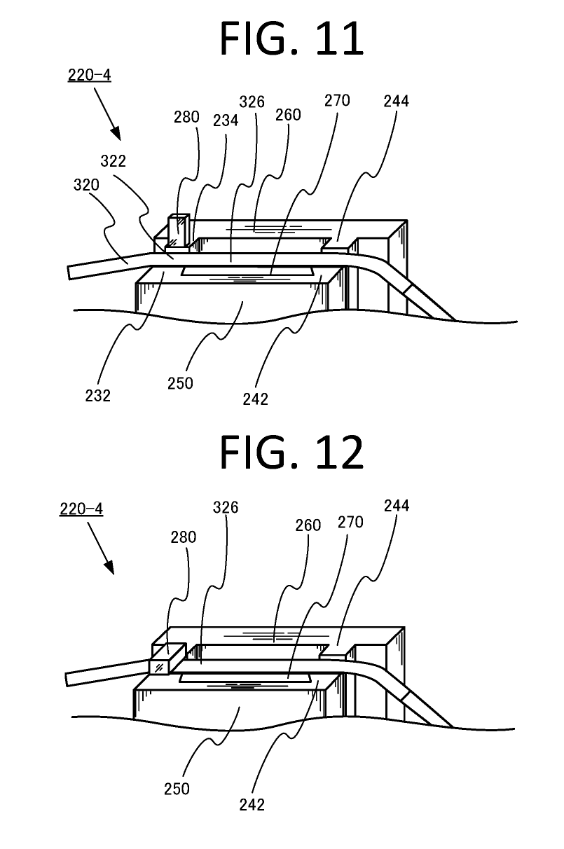

FIGS. 11-12 illustrate alternative perspective views of the second terminal 220 according to the fourth embodiment of the present invention. In this embodiment, the second terminal 220 may further include a stopper 280, as can be seen in FIGS. 11-12. The stopper 280 is provided on the first projecting strip member 234. The stopper 280 is configured to prevent the first part 322 of the winding finish part 320 from being released from the first holding part 230.

That is, as shown in FIGS. 11-12, the stopper 280 is displaceable between a first position (FIG. 11) and a second position (FIG. 12). The first position is a position in which the stopper 280 does not prevent the winding finish part 320 from being inserted into the first holding part 230. In the first position, the stopper 280 stands on the first projecting strip member 234. The second position is a position in which the stopper 280 prevents the winding finish part 320 from being released from the first holding part 230. In the second position, the stopper 280 lies between the first projecting strip members 232, 234.

Therefore, in the fourth embodiment of the present invention, it becomes possible to prevent the release of winding finish part 320 from the first holding part 230 after the winding finish part 320 is inserted into the first holding part 230.

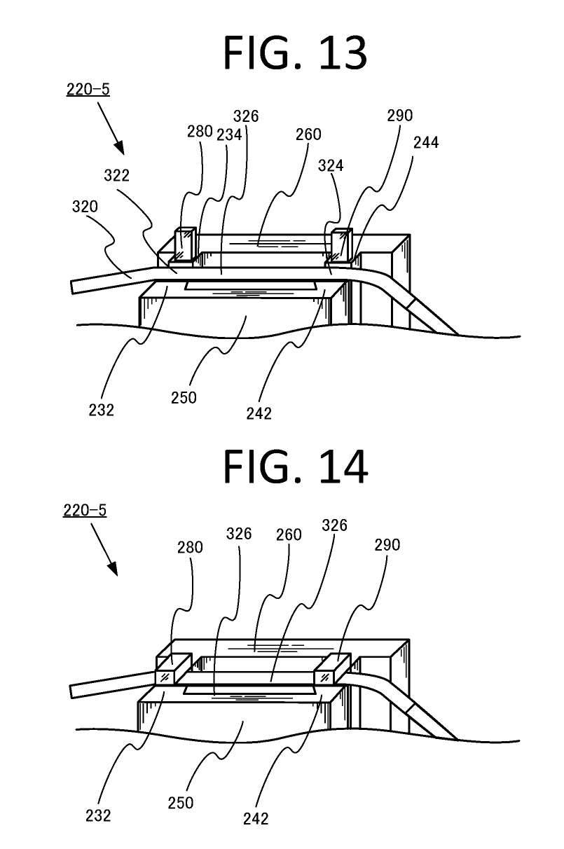

In the fourth embodiment of the present invention, only one stopper 280 is provided. However the number of the stopper is not limited to only one. For example, FIGS. 13-14 illustrate alternative perspective views of the second terminal 220 according to the fifth embodiment of the present invention. In the fifth embodiment, the second terminal 220 may include two stoppers 280, 290. The stopper 280 is provided on the first projecting strip member 234 while the stopper 290 is provided on the second projecting strip member 244. The stoppers 280, 290 are configured to prevent the release of the first part 322 and the second part 324 of the winding finish part 320 from the first holding part 230.

That is, as shown in FIGS. 13-14, the stoppers 280, 290 are displaceable between a first position (FIG. 13) and a second position (FIG. 14). The first position is a position in which the stoppers 280, 290 do not prevent the winding finish part 320 from being inserted into the first holding part 230 and the second holding part 240. In the first position, the stoppers 280, 290 stand on the first projecting strip member 234 and the second projecting strip member 244. The second position is a position in which the stoppers 280, 290 prevent the winding finish part 320 from being released from the first holding part 230 and the second holding part 240. In the second position, the stopper 280 lies between the first projecting strip members 232, 234, and the stopper 290 lies between the second projecting strip members 242, 244.

Therefore similar to the fourth embodiment, in the fifth embodiment of the present invention, it becomes also possible to prevent the release of the winding finish part 320 from the first holding part 230 and the second holding part 240 after the winding finish part 320 is inserted into the first holding part 230 and second holding part 240.

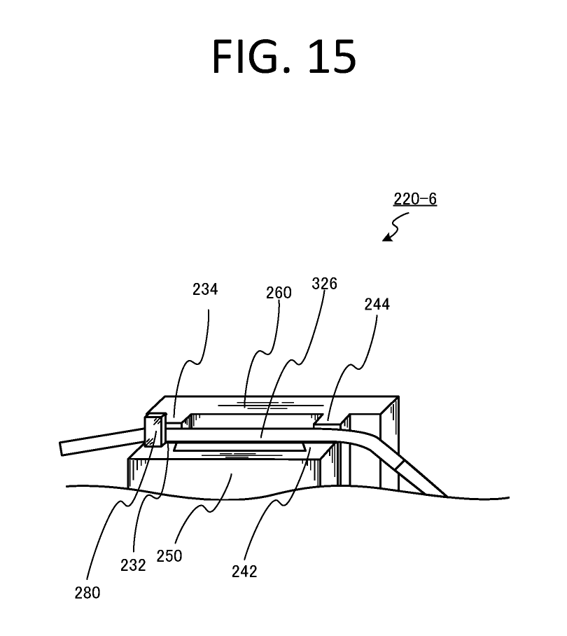

Furthermore, the stoppers 280, 290 may be provided on either the first wall 250 side or the second wall 260 side. Referring next to FIG. 15, a perspective view of the second terminal 220 according to the sixth embodiment of the present invention is shown. As shown in this figure, the stopper 280 can be provided on the first projecting strip members 232. The stopper 280 is displaceable between a first position (FIG. 15) and a second position (not shown). The first position is a position in which the stopper 280 does not prevent the winding finish part 320 from being inserted into the first holding part 230. In the first position, the stopper 280 stands on the first projecting strip member 232. The second position is a position in which the stopper 280 prevents the winding finish part 320 from being released from the first holding part 230. In the second position, the stopper 280 lies between the first projecting strip members 232, 234.

Accordingly, similar to the previous embodiments (fourth and fifth), in the sixth embodiment, it becomes also possible to prevent the release of the winding finish part 320 from the first holding part 230 after the winding finish part 320 is inserted in the first holding part 230.

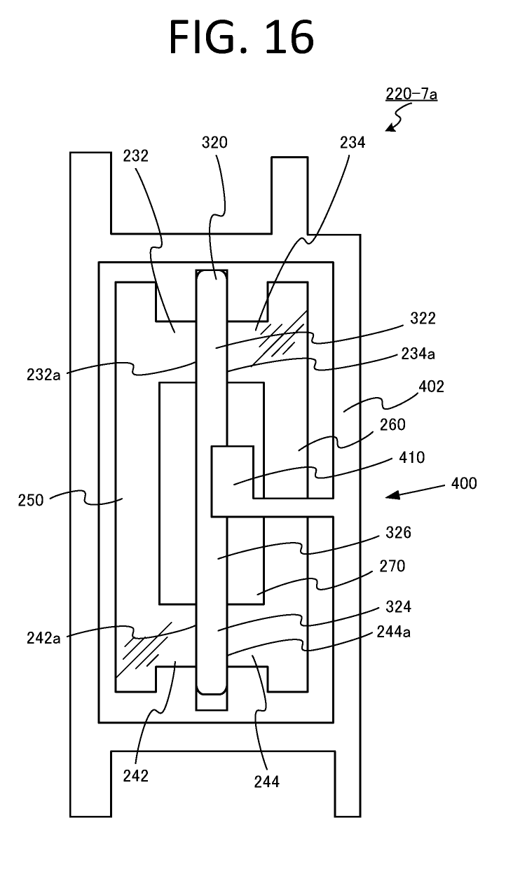

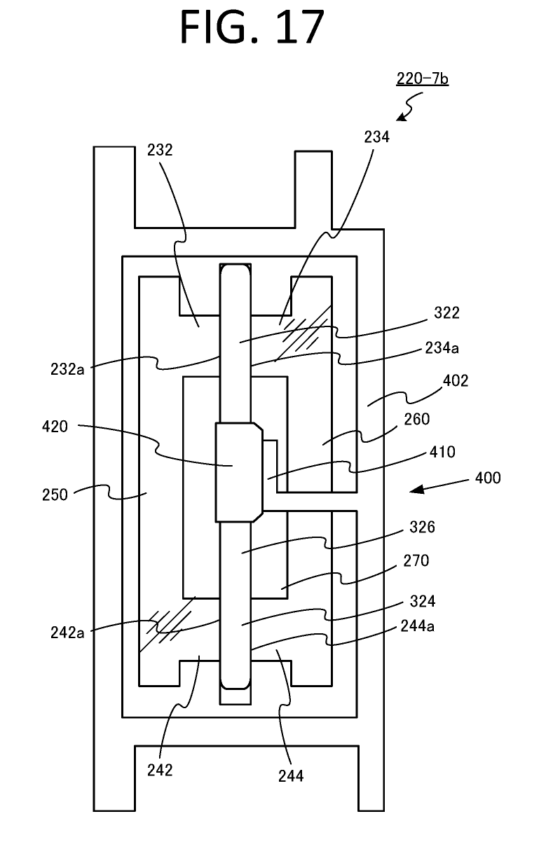

With reference to FIG. 16, a top view of the second terminal 220 according to the seventh embodiment of the present invention is shown. FIG. 17 illustrates a top view showing an alternative embodiment of the second terminal 220 depicted in FIG. 16. As shown in these figures, the coil assembly 1000 may further include an attachment 400. The attachment 400 is configured to connect to the intermediate part 326 of the winding finish part 320. Exemplary attachments 400 may include the embodiments shown in FIGS. 16-17, but are not limited to a plate spring 400. The coil assembly 1000 including the plate spring 400 is provided in electric devices, such as smart phones, tablets, etc for driving a lens of a camera.

As shown in FIG. 16, the plate spring 400 includes a frame body 402 and a connection part 410. The connection part 410 is projected inside the frame body 402. On the other hand, in the alternative embodiment, the intermediate part 326 and the plate spring 400 (the connection part 410) are connected by soldering 420, as shown in FIG. 17. However the intermediate part 326 and the plate spring 400 (the connection part 41) can be connected by welding. Accordingly, in the seventh embodiment, it becomes possible to connect easily the plate spring 400 to the intermediate part 326 of the winding finish part 320.

While the principles of the disclosure have been described above in connection with specific apparatuses, it is to be clearly understood that this description is made only by way of example and not as limitation on the scope of the invention.

What is claimed is:

1. A coil assembly comprising:
a bobbin; and
a coil wound around the bobbin;
wherein:
the bobbin comprises a terminal configured to hold a winding start part or a winding finish part of the coil, the terminal comprises:
a first holding part configured to hold a first part of the winding start part or the winding finish part, and
a second holding part configured to hold a second part of the winding start part or the winding finish part, the second holding part being apart from the first holding part.

2. The coil assembly according to claim 1, wherein the first holding part comprises a pair of first projecting strip members projected from the bobbin, said pair of first projecting strip members each having a first clipping surface configured to clip the first part of the winding start part or the winding finish part, and
wherein the second holding part comprises a pair of second projecting strip members projected from the bobbin, said pair of second projecting strip members each having a second clipping surface configured to clip the second part of the winding start part or the winding finish part.

3. The coil assembly according to claim 1, wherein the terminal further comprises a first wall and a second wall provided on the bobbin, said first and second walls being opposed to each other, wherein:
one of the pair of first projecting strip members is formed inside the first wall, while the other one of the pair of first projecting strip members is formed inside the second wall, and
one of the pair of second projecting strip members is formed inside the first wall, while
the other one of the pair of second projecting strip members is formed inside the second wall.

4. The coil assembly according to claim 1, wherein the terminal further comprises a support part configured to support an intermediate part of the winding start part or the winding finish part, said intermediate part being formed between the first part and the second part of the winding start part or the winding finish part.

5. The coil assembly according to claim 4, wherein the support part is provided between the first holding part and the second holding part.

6. The coil assembly according to claim 1, wherein the terminal further comprises a stopper configured to prevent the winding start part or the winding finish part from being released from the first holding part or the second holding part.

7. The coil assembly according to claim 6, wherein the stopper is provided at least on one of the first holding part and the second holding part.

8. The coil assembly according to claim 6, wherein the stopper is displaceable between a first position at which the stopper does not prevent the winding start part or the winding finish part from being inserted into the first holding part or the second holding part, and a second position at which the stopper prevents the winding start part or the winding finish part from being released from the first holding part or the second holding part.

9. The coil assembly according to claim 8, further comprising an attachment configured to connect to an intermediate part of the winding start part or the winding finish part, said intermediate part being formed between the first and second parts of the winding start part or the winding finish part.

10. The coil assembly according to claim 9, wherein the attachment comprises a plate spring.

11. The coil assembly according to claim 10, wherein the intermediate part and the plate spring are connected by soldering or welding.

12. A method for manufacturing a coil assembly, the method comprising the steps of:
holding a first part of a winding start part or a winding finish part of a coil to a first holding part of a terminal of a bobbin, and
holding a second part of the winding start part or the winding finish part to a second holding part of the terminal, the second holding part being apart from the first holding part.

13. The method as recited in claim 12, wherein the step of holding the first part comprises clipping the first part of the winding start part or the winding finish part between first clipping surfaces, said first clipping surfaces being formed on a pair of first projecting strip members which are projected from the bobbin, and
wherein the step of holding the second part comprises clipping the second part of the winding start part or the winding finish part between second clipping surfaces, said second clipping surfaces being formed on a pair of second projecting strip members which are projected from the bobbin.

14. The method as recited in claim 13, wherein the pair of first projecting strip members being provided inside a first wall and a second wall, wherein said first and second walls are provided on the bobbin and are opposed to each other, and wherein the pair of second projecting strip members being provided inside said first and second walls.

15. The method as recited in claim 12 further comprising a step of supporting an intermediate part of the winding start part or the winding finish part on a support part, said support part being provided between the first holding part and the second holding part, the intermediate part being formed between the first part and the second part of the winding start part or the winding finish part.

16. The method as recited in claim 12 further comprising a step of preventing the winding start part or the winding finish part from being released from the first holding part or the second holding part using a stopper, said stopper being provided at least on one of the first and second holding parts.

17. The method as recited in claim 16, wherein the preventing step comprises a step of displacing the stopper from a first position at which the stopper does not prevent the winding start part or the winding finish part from being inserted into the first holding part or the second holding part, to a second position at which the stopper prevents the winding start part or the winding finish part from being released from the first holding part or the second holding part.

18. The method as recited in claim 12 further comprising a step of connecting an attachment to an intermediate part of the winding start part or the winding finish part, said intermediate part being formed between the first and second parts of the winding start part or the winding finish part.

19. The method as recited in claim 12 further comprising a step of connecting a plate spring to an intermediate part of the winding start part or the winding finish part, said intermediate part being formed between the first part and second parts of the winding start part or the winding finish part.

20. The method as recited in claim 19, wherein the step of connecting the plate spring to the intermediate part comprises soldering or welding the plate spring to said intermediate part.
